(19) United States
(12) Patent Application Publication
(10) Pub. No.: US 2013/0095966 A1
(43) Pub. Date: Apr. 18, 2013

(54) FLEXIBLE ROTARY BELT DRIVE TENSIONER

(71) Applicant: Eric D. Staley, Flushing, MI (US)

(72) Inventor: Eric D. Staley, Flushing, MI (US)

(73) Assignee: GM GLOBAL TECHNOLOGY OPERATIONS LLC, Detroit, MI (US)

(21) Appl. No.: 13/274,522

(22) Filed: Oct. 17, 2011

(51) Int. Cl. F16H 7/12; F16F 7/06

(52) U.S. Cl. 474/135; 188/381

(57) ABSTRACT

A rotary belt drive tensioner including a damping mechanism decoupled from the torque output and pulley alignment of the tensioner such that the damping force and the torque output may be independently variable. The damping mechanism includes a shoe plate and at least one shoe set includes a damping shoe and a shoe spring. The shoe plate is operatively attached to one of the arm and the base, and the shoe spring exerts a radial load on the damping shoe in sliding engagement with the other of the arm and the base to generate a flexible damping force. In one embodiment, the rotary belt drive tensioner includes a damping mechanism containing three damping shoe sets positioned generally equidistant from each other on the shoe plate.

### TECHNICAL FIELD

The present invention relates to a rotary belt drive tensioner including a damping mechanism.

### BACKGROUND

A rotary belt drive tensioner typically includes a pulley journaled to an arm which is rotatable about a pivot fixed relative to a tensioner base. A torsion element, which is typically a torsion spring, is operatively connected to the base and to the arm to exert a torque output on the arm, biasing the position of the arm and the pulley. The pulley may be in communication with a belt, such that the biasing of the pulley causes the pulley to impart a load on the belt, acting to tension the belt. The tensioner may be configured for use in an accessory drive system of an engine, where the belt may be used to drive one or more accessory elements such as an alternator or compressor.

A pivot bushing may be used between the pivot and the arm, to act as a bearing surface or alignment element during rotation of the arm, and to carry the load of a moment or couple which may be introduced by the pulley through the arm, and to maintain the alignment of the pulley and arm to the tensioner base. In a typical configuration, the pivot bushing may be in operative communication with the torsion spring and/or a damping mechanism, such that unequal pressure loads may be introduced to the pivot bushing, by one or both of the torsion spring and the damping mechanism, causing bushing wear and/or pulley misalignment over the life of the tensioner. When the pulley is offset to the base of the tensioner, unequal pressure loads may be introduced to the bearing surfaces of the pivot bushing, which may result in bushing wear and pulley and/or belt misalignment over the life of the tensioner.

The tensioner may include a damping mechanism to inhibit or damp the oscillatory movement of the tensioner arm caused by operation of the belt drive. The damping mechanism may be operatively connected to the torsion spring, such that the torsion spring is also used to activate the damping mechanism to generate a normal force component to a friction sliding surface to dampen or inhibit oscillatory movements of the tensioner arm. The load exerted by the torsion spring on the damping mechanism may cause non-uniform or unequal wear of the damping mechanism, which may result in decreased damping effectiveness.

Often, in order to maintain constant torque transmission between a belt and a pulley with low belt wrap or high inertia, the torque output of the tensioner is increased to apply more belt tension, which may increase parasitic losses and accelerate belt wear. In many conventional tensioners, the amount of damping is coupled to and/or directly proportional to the spring torque and/or torque output, and the resulting damping level is not optimized. In a low belt wrap configuration with a conventional tensioner, where the damping mechanism is actuated by the spring torque, the tensioner arm may not be sufficiently rotated to actuate the damping mechanism to provide adequate damping force. Also, as the damping shoe wears over the life of the tensioner, the damping level may become unstable, which can lead to performance and noise, vibration and/or harshness (NVH) issues.

In tensioner applications where the damping is decoupled from the torque, the damping level may be coupled to the pulley alignment. This relationship may result in higher damping levels than desirable, which may reduce the performance of the accessory drive system, and/or accelerate wear of the alignment element, which may typically be configured as a pivot bushing. Coupling of the torque output, damping, and/or pulley alignment can cause parasitic losses in the system, which can affect performance of the accessory drive system.

### SUMMARY

A rotary belt drive tensioner including a damping mechanism is provided. The tensioner may include a tensioner arm rotatably connected to a tensioner base, and a torsion element operatively connected to the tensioner base and the tensioner arm and configured to generate a torque output on the tensioner arm. The tensioner may further include a pulley journaled to the tensioner arm, and an alignment element interposed between the tensioner arm and the tensioner base and configured to align the arm, thereby aligning the pulley journaled to the arm. The tensioner is configured such that the damping mechanism is decoupled from the torque output and pulley alignment, and such that the damping force and the torque output may be independently variable. By decoupling the tensioner parameters of damping, torque output and pulley alignment in a rotary belt tensioner, the tensioner is made fully flexible, e.g., each of the tensioner parameters can be independently varied such that the tensioner can be optimized for the requirements of a belt driven system, which may be an accessory drive system of an engine, while minimizing the parasitic losses and/or component wear which may result when tensioner parameters must be coupled.

The damping mechanism may include a shoe plate and at least one shoe set, wherein the shoe plate is operatively attached to the arm. The shoe set includes a damping shoe and a shoe spring where the shoe spring is interposed between the shoe plate and the damping shoe such that the damping shoe is radially loaded by the shoe spring and is in sliding engagement with the base to generate a damping force, and such that the tensioner may be configured so that the damping force may be varied independently of either of the output torque and pulley alignment. The damping mechanism is configured to stabilize the damping level over the life of the tensioner, for example, by compensating for wear of the damping shoe using the radial force exerted on the shoe by the shoe spring. In one embodiment, the rotary belt drive tensioner includes a damping mechanism containing three damping shoe sets, each set positioned generally equidistant from another set on the shoe plate. In another configuration, the shoe plate may be operatively attached to the base, and the at least one damping shoe may be slidably engaged with the arm to generate a damping force.

The above features and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic perspective illustration of a rotary belt drive tensioner including a damping mechanism;

FIG. 2 is a schematic top view of the tensioner of FIG. 1;

FIG. 3 is a schematic cross-sectional view of section 3-3 of the tensioner of FIG. 1;

FIG. 4 is a schematic cross-sectional view of section 4-4 of the tensioner of FIG. 3;

FIG. 5 is a schematic perspective view illustrating other configurations of the shoe plate of the damping mechanism of FIG. 1;

FIG. 6 is a schematic perspective illustration of another configuration of the damping mechanism of FIG. 1;

FIG. 7 is a schematic perspective illustration of another configuration of a rotary belt drive tensioner including a damping mechanism; and

FIG. 8 is a schematic cross-sectional view of section 8-8 of the tensioner of FIG. 7.

### DETAILED DESCRIPTION

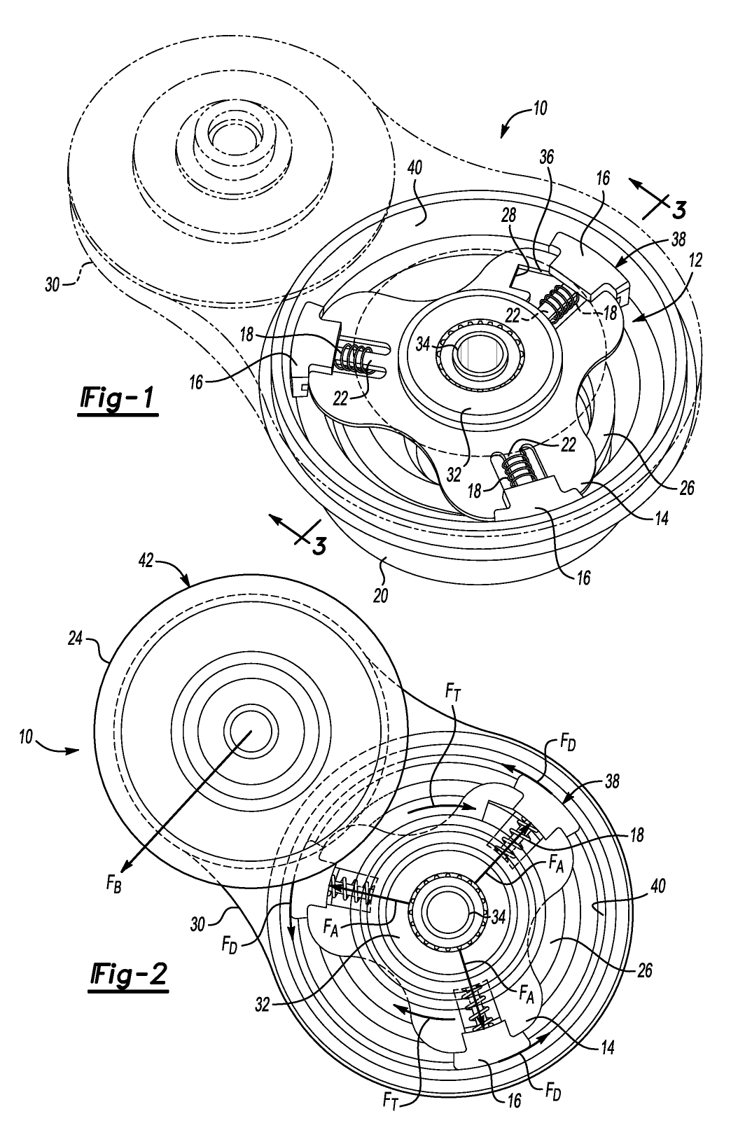

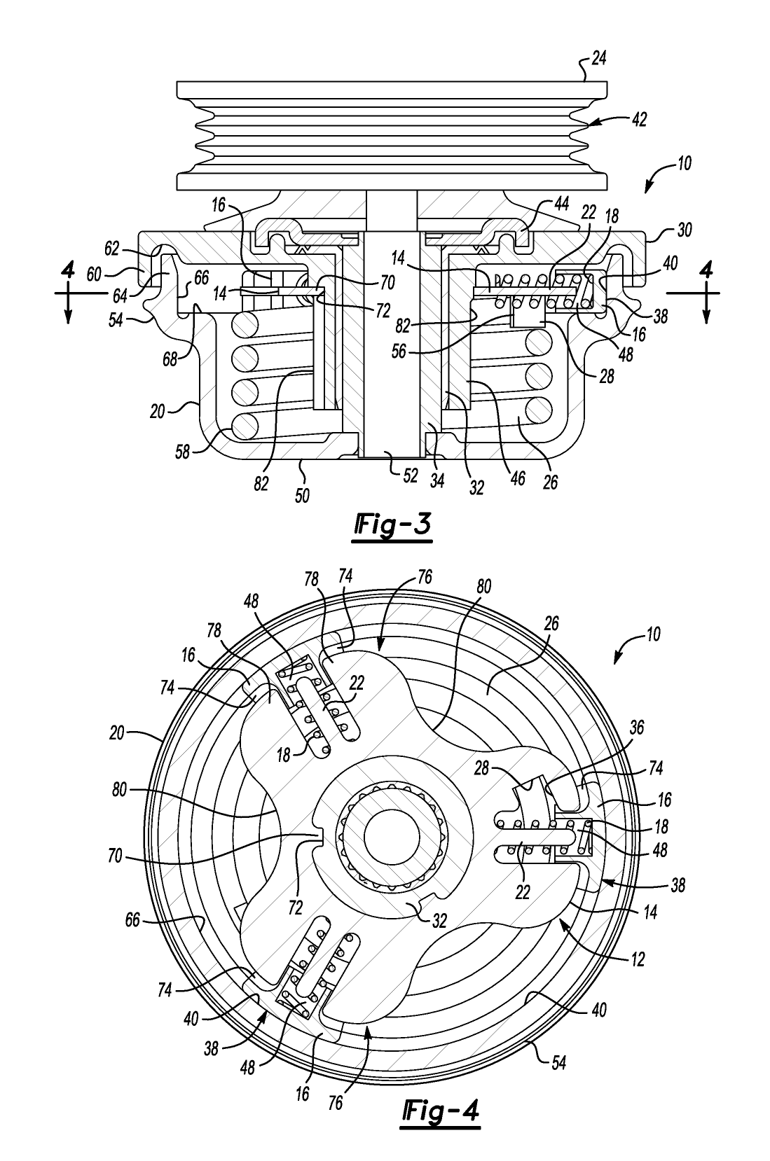

Referring to the drawings wherein like reference numbers represent like components throughout the several figures, the elements shown in FIGS. 1-8 are not necessarily to scale or proportion. Accordingly, the particular dimensions and applications provided in the drawings presented herein are not to be considered limiting. Referring to FIGS. 1-4, shown is a rotary belt drive tensioner generally indicated at 10 and including a tensioner base 20 housing a torsion element 26, and a tensioner arm 30 rotatably connected to the tensioner base 20. The torsion element 26, which may be configured as a torsion spring, may be operatively attached at a first end 56 (see FIG. 3) to the tensioner arm 30 and at a second end 58 (see FIG. 3) to the tensioner base 20 such that the torsion spring 26 may generate a torque output F_{T} on the arm 30 which may cause the arm 30 to rotate with respect to the base 20. A pulley 24 may be rotatably connected to the arm 30 such that as the arm 30 rotates in response to the torque output F_{T}, and in opposition to a belt force F_{B} provided by a belt (not shown) engaged by the pulley 24, thereby tensioning the belt on the pulley 24. The tensioner 10 further includes a damping mechanism generally indicated at 12, which may also be referred to herein as a shoe plate assembly, configured to provide a damping force F_{D} to dampen or inhibit oscillatory movements and vibrations of the tensioner arm 30. The tensioner 10 may be configured as a belt tensioner for use in a belt driven system, for example, in an accessory drive system of a vehicle (not shown).

The tensioner 10 and damping mechanism 12 as described in further detail herein are configured such that the damping force F_{D} is decoupled from the torque output F_{T} of the tensioner 10 to provide a flexible tensioner 10, where flexible as used herein indicates that the tensioner 10 may be configured with a torque output F_{T} and a damping force F_{D} that are independently variable, e.g., the tensioner 10 may be configured to provide a damping level F_{D} which may be disproportional to and/or decoupled from the torque output F_{T} to optimize performance of the tensioner 10.

The tensioner 10 and damping mechanism 12 are further configured such that the damping force F_{D} is decoupled from alignment of the arm 30 and/or pulley 24 with respect to the base 20 to provide a flexible tensioner 10, where flexible as used herein indicates that the tensioner 10 may be configured such that the damping force F_{D} is independent of the alignment of the arm 30 and/or pulley 24. The flexible tensioner 10 may be configured such that the damping mechanism 12 is decoupled from an arm alignment element 32, which may be, for example and as shown in FIG. 3, a pivot bushing configured to interface with a hub member 46 of the arm 30 and a pivot shaft 34 of the base 20 to resist misalignment of the arm 30 and/or pulley 24 to the base 20. The damping level F_{D} may be independently variable from the alignment of the arm 30 and/or pulley 24 to the base 20, such that as the pivot bushing 32 is subjected to misaligning forces which may include the belt force F_{B}, and/or wear, the damping level F_{D} is substantially unaffected by the alignment of the arm 30 and/or the condition of the alignment element 32.

In a fully flexible configuration, the tensioner 10 may be configured such that the damping mechanism 12 is decoupled from the torque output F_{T} and from alignment of the arm 30 and pulley 24 such that the tensioner 10 may be configured with a damping level F_{D} that is independently variable from both the torque output F_{T} and the alignment of the arm 30 and pulley 24, and where the damping level F_{D} and the torque output F_{T} may be configured at various and disproportional levels to facilitate optimization of the performance of the tensioner 10.

A number of non-limiting examples are provided to illustrate advantages which may be provided by a flexible tensioner 10. In a first example, the tensioner 10 may be configured for use with a belt driven system of an engine (not shown) which may have an aggressive torsional vibration curve, which may be a smaller engine such as a 2-cylinder or 3-cylinder engine, where a tensioner combination of a high damping force F_{D} and low torque output F_{T} may be advantageous to manage vibration and minimize rotational movement of the arm, wear of the alignment bushing 32, and parasitic losses, while optimizing fuel economy.

In another example including a tensioner 10 in a system with low belt wrap, the tensioner 10 may be configured with a high torque output F_{T} to minimize rotation of the tensioner arm 30, which in combination with a minimum level of damping F_{D} at small rotations of the tensioner arm 30 may prevent belt slippage.

In another example, a tensioner 10 may be in communication with a high inertia component, such as a high inertia alternator (not shown), where without sufficient damping the tensioner arm 30 may be rotated too fast to absorb torque pulses. In this scenario, a high ambient damping force F_{D} may be desired to decrease the speed of rotation of the arm 30 and improve absorption of the high inertia torque pulse by the tensioner 10.

In another example, the tensioner 10 may include an isolation device (not shown), such as a decoupler pulley, such that some torque pulses may be absorbed through the pulley 24. In this example, the tensioner 10 may be configured to provide a very low damping level F_{D} so as not to inhibit movement of the tensioner arm 30, thereby avoiding seizing of the tensioner 10 due to non-movement of the arm 30. The damping level F_{D}, torque output F_{T}, and alignment of the arm 30 to the base 20 may be independently tuned, e.g., each of these tensioner parameters may be separately varied, such that the need for an isolation device may be eliminated, and/or parasitic losses reduced.

As shown in FIGS. 1-8, the damping mechanism 12 includes a damping interface defined by a damping surface 38 in slidable contact with a damping surface 40. The interface surface 38 may be continuously loaded, for example, by a damping spring 18, against the damping surface 40, to stabilize the damping level F_{D} over the life of the tensioner 10, to compensate or overcome wear of the damping interface surfaces 38, 40 of the damping mechanism 12, and/or to provide a level of damping when the tensioner 10 is in a non-rotating condition. The damping spring 18 may also be referred to herein as a shoe spring. The damping mechanism 12 may be decoupled from alignment of the pulley 24 and/or of the arm 30 to the base 20, and from the torque output F_{T}, to minimize wear of the pulley alignment mechanism, e.g., to increase the durability of the alignment mechanism which may include the pivot bushing 32. Accordingly, the tensioner system 10 provided herein, e.g., is configured such that damping F_{D}, torque output F_{T}, and pulley alignment are decoupled and such that each of these tensioner parameters are independently variable, to provide numerous advantages as described.

Referring to FIGS. 1-4, shown is the tensioner 10 including the tensioner arm 30 and the tensioner base 20. The tensioner base 20 may be made stationary, for example, by fastening the base 20 to an engine block or to an accessory (not shown). A mounting surface 50 of the base 20 may be fastened in contact with a surface of the engine block, for example, using a bolt (not shown) engagable with a bolt hole 52 and the engine block. The bolt hole 52 may be defined by a pivot shaft 34 of the base 20. The tensioner base 20, which may also be referred to as a spring case or spring casing, may be configured to house a torsion element 26. A rim portion 54 of the tensioner base 20 may include an edge portion 64 configured to interface with a cover portion 60 of the arm 30. For example, as shown in FIG. 3, the edge portion 64 may be received by a channel or lip portion 62 of the cover portion 60. The tensioner base 20 may typically be made from a metallic material, such as an iron-based or aluminum based material. A dust shield or seal 44 may be provided to protect the internal components of the tensioner 10 from ingression of contaminants, etc.

The tensioner arm 30 may be rotatably connected to the tensioner base 20, for example, via a hub member 46 of the tensioner arm 30 rotatably engaged with the pivot shaft 34 of the base 20. The hub member 46 may also be referred to herein as a hub, and may be configured as a generally cylindrical member. A pivot bushing 32, which may also be referred to herein as an alignment element, may be interposed between the hub 46 and the pivot shaft 34 to align the arm 30 to the base 20, thereby aligning the pulley 24 to the base 20. The pulley 24 may be journaled to the tensioner arm 30, and may define a pulley surface 42 configured to receive a belt (not shown). The pulley surface 42 may be grooved, flat, flanged, etc., as required by the configuration of the belt in communication therewith. The belt may exert a belt load F_{B} on the pulley 24 and the arm 30. The pivot bushing 32 may be configured to compensate for and/or resist misaligning loads, such as the belt load F_{B} exerted on the pulley 24 and arm 30, and over time, may be subject to wear due to these misaligning loads.

The torsion element 26, which may be configured as a torsion spring, may be connected to the tensioner base 20 and operatively connected to the tensioner arm 30 and configured to generate a torque output F_{T} on the tensioner arm 30 to resist the belt load F_{B} and to tension a belt in communication with the pulley 24. The torsion spring 26 may typically be preloaded to provide the torque output F_{T} on the pulley 24 to rotate the tensioner arm 30 to oppose the belt force F_{B}. The torque output F_{T} of the torsion spring 26 may be tunable, e.g., may be variable, by varying, for example, at least one of the spring force and the preload of the torsion spring 26, or by varying other characteristics of the torsion spring 26, such that the torque output F_{T} may be set higher or lower for a tensioner 10.

The damping mechanism 12 includes a shoe plate 14, and at least one shoe set including a damping shoe 16 and a shoe spring 18. The shoe plate 14 may be formed from a metallic material, such as an iron-based or aluminum-base material, for example, or may be made of a non-metallic material of sufficient strength and configuration to support and guide the damping shoe(s) 16 and shoe spring(s) 18 which are operatively connected to the shoe plate 14 to comprise the damping mechanism 12. The shoe plate 14 may be attached to one of the arm 30 and the base 20 and configured such that the damping shoe(s) 16 interface with a surface of the other of the arm 30 and the base 20, to allow relative movement between the damping shoe(s) 16 and the interfacing surface, thereby providing a damping force F_{D} to the tensioner 10. The damping force F_{D} may include elements of both viscous damping and Coulomb damping. The damping mechanism 12 is configured to provide a damping force F_{D} when the tensioner arm 30 is rotated in a clockwise and in a counterclockwise direction, with respect to FIG. 2 as shown on the page.

In a first example configuration shown in FIGS. 1-4, the shoe plate 14 is attached to the tensioner arm 30, and the shoe spring 18 is interposed between the shoe plate 14 and the damping shoe 16 such that the damping shoe 16 is radially loaded by the shoe spring 18 and is in sliding engagement with the base 20 to generate the damping force F_{D} The shoe plate 14 may be attached to the arm 30, for example, at an interface 72 by establishing an interference fit between the shoe plate 14 and the hub 46, by welding or brazing the shoe plate 14 to the surface 82 of the hub 46, by staking the shoe plate 14 to the hub 46, by the use of an adhesive, by a combination of two or more of these, or by other suitable means to fixedly attach the shoe plate 14 to the hub 46. The shoe plate 14, thus attached, is rotated by the hub 46 when the tensioner arm 30 moves in response to input from the belt load F_{B} and/or the torque output F_{T}. One or more locating features 70 may be defined by the shoe plate 14 and/or hub 46 to align the shoe plate 14 to the hub 46.

In the example shown in FIGS. 1-4, the shoe plate 14 may include an attachment interface 28 to which the first end 56 of the torsion spring 26 may be attached. In the present example, the attachment interface 28 may be a tab 28 which may be formed, for example, by cutting and bending a portion of the plate 14 to form the tab 28 and a notch 36. The torsion element 26 may be attached at a first end 56 to attachment interface 28, such that the torsion element 26 is operatively attached to the tensioner arm 30 through the interface 72 defined by the attachment of the shoe plate 14 to the hub 46, and at a second end 58 to the tensioner base 20 such that the torsion spring 26 may generate a torque output F_{T} on the arm 30 which may cause the arm 30 and the attached shoe plate 14 to rotate with respect to the base 20.

In the example shown in FIGS. 1-4, a plurality of shoe springs 18 and a plurality of damping shoes 16 are positioned with respect to the shoe plate 14 such that each of the damping shoes 16 may be in sliding engagement with the base 20 to generate a damping force D_{F}, for example, when the shoe plate 14 is rotated by movement of the tensioner arm 30. The shoe spring 18 may also be referred to herein as a compression spring. The shoe spring 18 is interposed between the shoe plate 14 and the damping shoe 16 to provide an axial spring force F_{A} to radially load the damping shoe 16 in sliding engagement with the base 20. The axial spring force F_{A} may also be referred to herein as the radial force. The shoe spring 18 may be positioned with a first end in proximate contact with a spring guide 22 and with a second end in proximate contact with a spring seat 48, and may be preloaded, to provide the spring force F_{A}.

The spring guide 22 may be defined by the shoe plate 14 and configured to receive the shoe spring 18. In the non-limiting example shown in FIGS. 1-4, the spring guide 22 is configured as a spring post. The spring guide 22 may be otherwise configured, for example, as a pocket, spring seat, tab, or other attaching or supportive interface defined by the shoe plate 14 and configured to receive one end of the shoe spring 18. The spring seat 48 may be defined by the damping shoe 16 and configured to receive the other end of the shoe spring 18. In the non-limiting example shown in FIGS. 1-4, the spring seat 48 is configured as a pocket or recess. The spring seat 48 may be otherwise configured, for example, as a post, tab, or other attaching or supportive interface defined by the damping shoe 16 and configured to receive the shoe spring 18. The shoe spring 18 may be connected to one or both of the spring guide 22 and the spring seat 48, for example, to retain the damping shoe 16 to the shoe plate 14, and/or to facilitate assembly of the damping mechanism 12 in the tensioner 10. The shoe spring 18 and the damping shoe 16 may be collectively referred to as a shoe set, or a shoe assembly.

The damping shoe 16 may define a damping surface 38, which may also be referred to as a first damping surface or a shoe damping surface. The shoe damping surface 38 is held in slidable contact with a damping surface 40 which may be referred to as a second damping surface. The damping shoe 16 and shoe spring 18 react with a radial force F_{A} against the secondary damping surface 40 of the stationary tensioner base 20 to create the damping force F_{D}. In the example shown in FIGS. 1-4, the secondary damping surface 40 is defined by an inner wall 66 of the rim portion 54 of the tensioner base 20. One or both of the damping surfaces 38, 40 may be wearing surfaces, e.g., one or both of the damping surfaces 38, 40 may wear over time as the surfaces are in slidable contact during operation of the tensioner 10 including rotation of the tensioner arm 30. The damping mechanism 12 may be configured to maintain the wearing surfaces 38, 40 in sliding engagement such that the wearing surfaces 38, 40 wear uniformly, to minimize noise vibration and harshness (NVH) in the tensioner 10 over time.

The damping shoe 16 may define a generally arcuate shape, such that the shoe damping surface 38 may be a generally arcuate surface. The shoe damping surface 38 may be shaped to generally conform with the second damping surface 40, e.g., in the present example, each may be defined by substantially the same radius, to maximize the area of contact or interface between the damping surfaces 38, 40, to generate uniform damping forces through the area of interface, to provide a generally smooth sliding contact between the surfaces 38, 40, and/or to provide for uniform wear of the surfaces 38, 40. The damping mechanism 12 may be configured such that the shoe spring 18 is preloaded to maintain a constant compressive load on the shoe 16 such that the damping surface 38 wears uniformly over time. In the example shown, uniform wear of the damping shoe 16 may be characterized by a consistent level of wear over the damping surface 38, such that the arcuate shape of the damping surface 38 is retained over time. The damping shoe 16 may be formed from a polymer-based material which is configured to provide sufficient strength characteristics to transmit the radial force F_{A} and to generate the damping force F_{D}, and with abrasion resistance to minimize wear as the result of sliding contact with the second damping surface 40. Examples of polymer-based materials which may be used to form the damping shoe 16 included but are not limited to thermoplastics including nylon-based materials, which may be reinforced, for example, with a filler material, such as a fiber or glass type material, for strength, durability and/or wear resistance.

The damping mechanism 12 may be configured to generate different levels of damping force F_{D}, for example, by modifying the configuration of the spring 18 to modify the level of radial force F_{A} exerted against the damping shoe 16, by modifying the configuration and/or material of the damping shoe 16, by modifying the damping surface 38 of the damping shoe 16, and/or by a combination of these.

The shoe plate 14 may define a shoe interface portion generally indicated at 76 in FIG. 4. The shoe interface portion 76 may include, as described previously, a spring guide 22, and at least one shoe guide portion 78, which may also be referred to herein as a shoe guide. In the example shown, the shoe guide 78 may be defined by a portion of the shoe plate 14 adjacent to the spring guide 22. The damping shoe 16 may define at least one plate guide portion 74, which may also be referred to herein as a plate guide. In the example shown in FIG. 4, the plate guide 74 may be generally configured as a slot or recess in the damping shoe 16 adjacent to the spring seat 48. The plate guide 74 is configured to receive the shoe guide 78, such that the plate guide 74 and the shoe guide 78 interface to stabilize the position of the damping shoe 16 with respect to the shoe plate 14 and the second interface 40, by minimizing the movement of the damping shoe 16 relative to the shoe plate 14 and preventing binding of the damping shoe 16. For example, during rotation of the damping mechanism 12 by the tensioner arm 30, the shoe guide 78 will contact the plate guide 74 to limit radial displacement or kicking side to side of the shoe 16 with respect to the plate 14. Similarly, the shoe guide 78 will contact the plate guide 74 to limit any twisting or axial displacement of the shoe 16 with respect to the plate 14. The shoe guide 78 and plate guide 74, and the interface therebetween, may also be configured to compensate for any change in the position of the shoe plate 14 with respect to the base 20 due to the alignment of the arm 30 to the base 20, wherein the alignment may be affected, for example, by a belt load F_{B} transmitted through the pulley 24 and arm 30, and/or by wear of the alignment element 32.

As shown in FIGS. 1-4 and described previously herein, the tensioner 10 is configured such that the damping force F_{D} generated by the damping mechanism 12 and the torque output F_{T} generated by the torsion spring 26 in communication with the tensioner arm 30 and the base 20 are decoupled such that each of these tensioner parameters, e.g., the damping force F_{D} and the torque output F_{T}, is independently variable. Because the shoe plate 14 is fixedly attached to the tensioner arm 30 at the interface 72, the torque output F_{T} may be generated by the torsion spring 26 and transmitted through the interface 72 with minimal or no influence on or proportionality to the damping force F_{D} generated by the shoe spring 18 and damping shoe 16 interfacing with second damping surface 40 of the tensioner base 20.

Because the torsion spring 26 may be tuned, e.g., modified to change the level of torque output F_{T} without influencing the damping mechanism 12 or damping force F_{D}, and because the damping mechanism 12 may be tuned, e.g., modified to change the level of damping force F_{D} without influencing the torsion spring 26 or the torque output F_{T}, various combinations of damping forces F_{D} and torque outputs F_{T} of the tensioner 10 are possible, thus making the tensioner 10 flexible in configuration with respect to its damping force F_{D} and torque output F_{T}. For example, a first tensioner 10 may be configured with a first torsion spring 26 providing a high torque output F_{T1} and with a first damping mechanism 12 providing a high damping force F_{D1}. A second tensioner 10 may be configured with the first torsion spring 26 providing high torque output F_{T1} and with a second damping mechanism 12 providing a low damping force F_{D2}. A third tensioner 10 may be configured with a second torsion spring 26 providing a low torque output F_{T2} and with the second damping mechanism 12 providing low damping force F_{D2}. A fourth tensioner 10 may be configured with the second torsion spring 26 providing low torque output F_{T2} and with the first damping mechanism 12 providing high damping force F_{D1}. The ability to configure the flexible tensioner 10 to optimize tensioner performance for the particular application, such as a low belt wrap or high inertia application, as described previously, is derived from the ability to independently vary the decoupled tensioner parameters of damping force F_{D} and torque output F_{T}.

Referring again to FIGS. 1-4 and described previously herein, the tensioner 10 is configured such that the damping force F_{D} generated by the damping mechanism 12 and the alignment of the tensioner arm 30 and/or pulley 24 to the tensioner base 20 are decoupled such that each of these tensioner parameters, e.g., the damping force F_{D} and the pulley/arm alignment, is independently variable. The alignment element 32, which in the example of FIG. 3 is shown as the pivot bushing 32 interposed between the pivot shaft 34 and the hub 46, is configured to respond to misaligning forces, such as the belt load F_{B}, or wear of the pivot bushing 32, with minimal or no influence on or proportionality to the damping force F_{D} generated by the shoe spring 18 and damping shoe 16 interfacing with second damping surface 40 of the tensioner base 20. As described previously, the shoe guide 78 and plate guide 74, and the interface therebetween, may compensate for any change in the position of the shoe plate 14 with respect to the base 20 due to the alignment of the arm 30 to the base 20, wherein the alignment may be affected, for example, by a belt load F_{B} transmitted through the pulley 24 and arm 30, or by wear of the alignment element 32. Because the damping mechanism 12 may be tuned, e.g., modified to change the level of damping force F_{D} without interacting with or modifying the alignment mechanism of the tensioner 10, the tensioner 10 may be flexible in configuration with respect to its damping force F_{D} and pulley/arm alignment.

In the fully flexible configuration of the tensioner 10 described herein, the damping mechanism 12 is decoupled from the torque output F_{T} and from alignment of the arm 30 and pulley 24 such that the tensioner 10 may be configured with a damping level F_{D} that is independently variable from both the torque output F_{T} and the alignment of the arm 30 and pulley 24, and where the damping level F_{D} and the torque output F_{T} may be configured at various and disproportional levels to facilitate optimization of the performance of the tensioner 10.

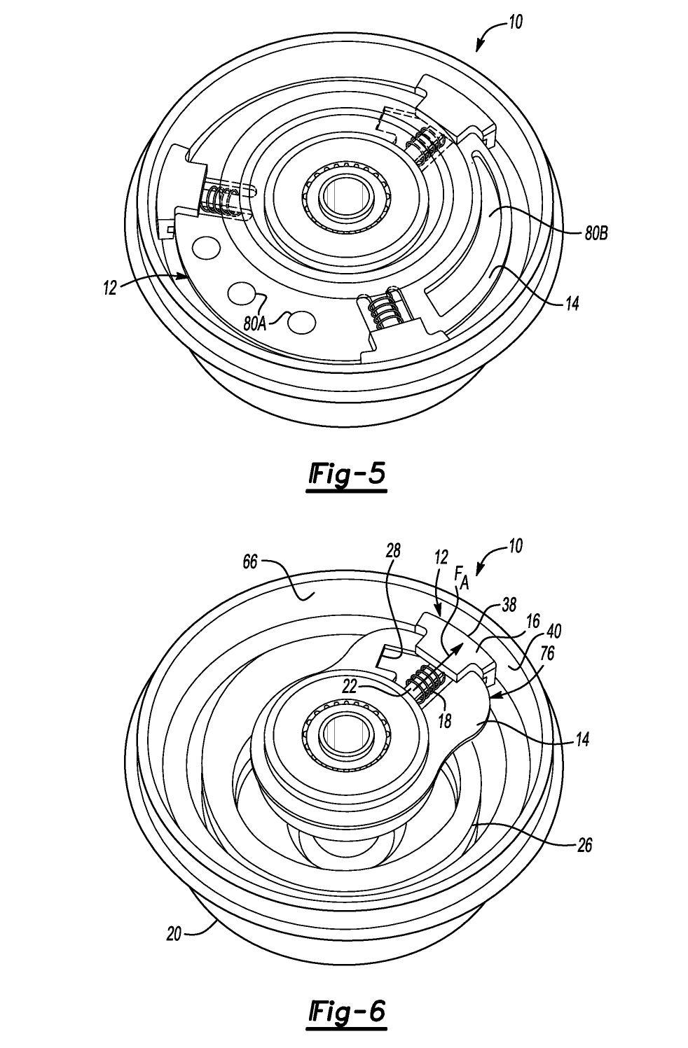

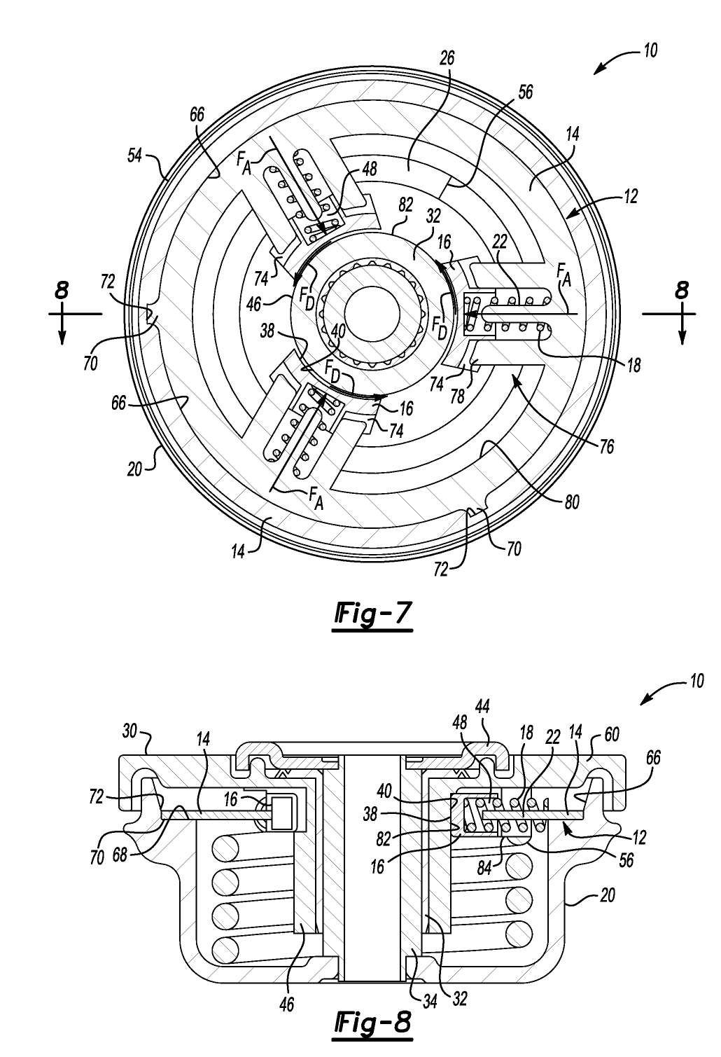

As shown in FIGS. 4-7, the shoe plate 14 may be configured to define one or more relieved portions 80, which may be configured as a recessed portion or an aperture in the shoe plate 14. The relieved portions 80 may be of any suitable configuration such that the shoe plate 14 is of sufficient strength and dimensional stability for functionality in the tensioner 10. The relieved portions 80 may serve to reduce the amount of material required to fabricate the shoe plate 14, to reduce the weight of the tensioner 10 for fuel economy, for example, to provide visual or physical access to components in the base 20, to increase air circulation in the tensioner 10 for cooling and evaporation of contaminates, for example, or a combination of these. For example, as shown in FIG. 4, the shoe plate 14 may define generally concave relieved portions 80 between the shoe interface portions 76. In another example shown in FIG. 5, the relieved portions may each be configured as an aperture such as a hole 80A or a slot 80B, which may be formed in the plate 14. In the example shown in FIG. 6, the number of shoe sets may be reduced to one, and the shoe plate 14 configured as a generally oval, teardrop or elliptical shape. In another example shown in FIG. 7, the shoe plate 14 may define generally wedge shaped openings providing physical access to the torsion spring 26. These examples are illustrative and are not intended to be limiting. For example, the damping mechanism 12 may be configured with any number of shoe sets and with a shoe plate 14 of any configuration such that the shoe sets are distributed on the shoe plate 14 to be slidably engaged with the interfacing surface 40 to provide a damping force F_{D}.

The number of shoe sets, e.g., the number of damping shoes 16 and shoe springs 18 comprising the damping mechanism 12 may be varied. As shown in FIGS. 1-5 in a first configuration, and in FIGS. 7-8 in a second configuration, a plurality of shoe sets may be included in the damping mechanism 12, wherein each respective shoe spring 18 is interposed between the shoe plate 14 and a respective damping shoe 16 such that each damping shoe 16 is radially loaded by the respective shoe spring 18 and is in sliding engagement with one of the arm 30 and the base 20 to generate a damping force. The plurality of shoe sets may preferably be, but are not required to be, positioned generally equidistant from each other on the shoe plate, for example, such that the axial forces F_{A} and/or the damping forces F_{D} may be generally in balance to each other.

As shown in FIG. 6, the damping mechanism 12 may be configured with a single damping shoe 16 and shoe spring 18. In each of these configurations, the damping mechanism 12 is decoupled from both the torsion spring 26 and the alignment element 32. The examples provided herein are intended to be non-limiting, and other configurations of damping mechanisms 12 including varying shapes of plates 14 and/or one or more damping elements 16 may be used.

FIGS. 7 and 8 show another configuration of the tensioner 10, wherein the shoe plate 14 is attached to the tensioner base 20, and the shoe spring 18 is interposed between the shoe plate 14 and the damping shoe 16 such that the damping shoe 16 is radially loaded by the shoe spring 18 and is in sliding engagement with the surface 82 of the arm 30 to generate the damping force F_{D} The shoe plate 14 may be attached to the base 20, for example, at an interface 72 by establishing an interference fit between the shoe plate 14 and the inner wall 66 of the rim portion 54 of the base 20, by welding or brazing the shoe plate 14 to the inner wall 66 and/or a shoulder 68 of the rim portion 54, by staking the shoe plate 14 to the rim portion 54, by the use of an adhesive, by a combination of two or more of these, or by other suitable means to fixedly attach the shoe plate 14 to the base 20. With the shoe plate 14 thus attached, the damping shoes 16 are placed in sliding engagement with the surface 82 of the rotating hub 46 when the tensioner arm 30 moves in response to input from the belt load F_{B} and/or the torque output F_{T}. One or more locating features 70 may be defined by the shoe plate 14 and/or base 20 to align the shoe plate 14 to the rim portion 54.

In the example shown in FIGS. 7-8, the cover portion 60 of the arm 30 may include an attachment interface 84 to which the first end 56 of the torsion spring 26 may be attached. In the present example, the attachment interface 84 may be a protrusion from the cover portion 60 which may be formed, for example, during the process of casting, stamping or otherwise forming the arm 30. The attachment interface 84 may protrude through a relieved portion or opening 80 defined by the shoe plate 14, such that the torsion element 26 may be attached at a first end 56 to the tensioner arm 30 at the attachment interface 84, and such that the arm 30 may be rotated with respect to the base 20 without interference of the spring element 26 and the shoe plate 14. The torsion element 26 may be attached at a second end 58 to the tensioner base 20, such that the torsion spring 26 may generate a torque output F_{T} on the arm 30 which may cause the arm 30 and hub surface 82 to rotate with respect to the damping mechanism 12 attached to the base 20.

The tensioner 10 shown in FIGS. 7-8 performs substantially as described for the tensioner 10 shown in FIGS. 1-6. In the example shown in FIGS. 7-8, a plurality of shoe springs 18 and a plurality of damping shoes 16 are positioned with respect to the shoe plate 14 such that each of the damping shoes 16 may be in sliding engagement with hub 46 to generate a damping force D_{F}, for example, when hub 46 is rotated by movement of the tensioner arm 30. The shoe damping surface 38 is held in slidable contact with a damping surface 40, which is defined by the surface 82 of the hub 46. The damping shoe 16 and shoe spring 18 react with a radial force F_{A} against the secondary damping surface 40 of the hub 46 to create the damping force F_{D}.

One or both of the damping surfaces 38, 40 may be wearing surfaces, e.g., one or both of the damping surfaces 38, 40 may wear over time as the surfaces are in slidable contact during operation of the tensioner 10 including rotation of the tensioner arm 30. The damping shoe 16 may define a generally arcuate shape, such that the shoe damping surface 38 may be a generally arcuate surface. The shoe damping surface 38 may be shaped to generally conform to the second damping surface 40 which is the hub surface 82, e.g., each may be defined by substantially the same radius. The damping mechanism 10 may be configured such that the shoe spring 18 is preloaded to maintain a constant compressive load on the shoe 16 such that the damping surface 38 wears uniformly over time. The damping mechanism 12 may be configured to generate different levels of damping force F_{D}, for example, by modifying the configuration of the spring 18 to modify the level of radial force F_{A} exerted against the damping shoe 16, by modifying the configuration and/or material of the damping shoe 16, by modifying the damping surface 38 of the damping shoe 16, and/or by a combination of these.

As described previously, the damping plate 14 may define at least one shoe guide 78, and the damping shoe 16 may define at least one plate guide 74. The plate guide 74 may be configured to receive the shoe guide 78, such that the plate guide 74 and the shoe guide 78 may interface to stabilize the position of the damping shoe 16 with respect to the shoe plate 14 and the second interface 40, by minimizing the movement of the damping shoe 16 relative to the shoe plate 14 and preventing binding of the damping shoe 16. For example, during rotation of the hub 46 by the tensioner arm 30, the shoe guide 78 will contact the plate guide 74 to limit radial displacement or kicking side to side of the shoe 16 with respect to the plate 14. Similarly, the shoe guide 78 will contact the plate guide 74 to limit any twisting or axial displacement of the shoe 16 with respect to the plate 14. The shoe guide 78 and plate guide 74, and the interface therebetween, may also be configured to compensate for any change in the position of the shoe plate 14 with respect to the hub 46 due to the alignment of the arm 30 to the base 20, wherein the alignment may be affected, for example, by a belt load F_{B} transmitted through the pulley 24 and arm 30, and/or by wear of the alignment element 32.

As shown in FIGS. 7-8, the tensioner 10 is configured such that the damping force F_{D} generated by the damping mechanism 12 and the torque output F_{T} generated by the torsion spring 26 in communication with the tensioner arm 30 and the base 20 are decoupled such that each of these tensioner parameters, e.g., the damping force F_{D} and the torque output F_{T}, is independently variable. Because the torsion element is directly attached to the arm cover 60 and the base 20, the torque output F_{T} may be generated by the torsion spring 26 and transmitted to the arm 30 with minimal or no influence on or proportionality to the damping force F_{D} generated by the shoe spring 18 and damping shoe 16 interfacing with second damping surface 40 of the hub 46.

Because the torsion spring 26 may be tuned, e.g., modified to change the level of torque output F_{T} without influencing the damping mechanism 12 or damping force F_{D}, and because the damping mechanism 12 may be tuned, e.g., modified to change the level of damping force F_{D} without influencing the torsion spring 26 or the torque output F_{T}, various combinations of damping forces F_{D} and torque outputs F_{T} of the tensioner 10 are possible, thus making the tensioner 10 flexible in configuration with respect to its damping force F_{D} and torque output F_{T}, as described previously. The ability to configure the flexible tensioner 10 to optimize tensioner performance for the particular application, such as a low belt wrap or high inertia application, as described previously, is related to the ability to independently vary the decoupled tensioner parameters of damping force F_{D} and torque output F_{T}.

Referring again to FIGS. 7-8 and described previously herein, the tensioner 10 is configured such that the damping force F_{D} generated by the damping mechanism 12 and the alignment of the tensioner arm 30 and/or pulley 24 to the tensioner base 20 are decoupled such that each of these tensioner parameters, e.g., the damping force F_{D} and the pulley/arm alignment, is independently variable. The alignment element 32, which in the example of FIG. 3 is shown as the pivot bushing 32 interposed between the pivot shaft 34 and the hub 46, is configured to respond to misaligning forces, such as the belt load F_{B}, or wear of the pivot bushing 32, with minimal or no influence on or proportionality to the damping force F_{D} generated by the shoe spring 18 and damping shoe 16 interfacing with second damping surface 40 of the hub 46, due at least in part to the shoe guide 78 and plate guide 74, and the interface therebetween being configured to compensate for any change in the position of the shoe plate 14 with respect to the hub 46 due to the alignment of the arm 30 to the base 20, wherein the alignment may be affected, for example, by a belt load F_{B} transmitted through the pulley 24 and arm 30, or by wear of the alignment element 32. Because the damping mechanism 12 may be tuned, e.g., modified to change the level of damping force F_{D} without interacting with or modifying the alignment mechanism of the tensioner 10, the tensioner 10 may be flexible in configuration with respect to its damping force F_{D} and pulley/arm alignment.

In the fully flexible configuration of the tensioner 10 described herein, the damping mechanism 12 is decoupled from the torque output F_{T} and from alignment of the arm 30 and pulley 24 such that the tensioner 10 may be configured with a damping level F_{D} that is independently variable from both the torque output F_{T} and the alignment of the arm 30 and pulley 24, and where the damping level F_{D} and the torque output F_{T} may be configured at various and disproportional levels to facilitate optimization of the performance of the tensioner 10.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. A rotary belt tensioner including a tensioner arm rotatably connected to a tensioner base, and a torsion element operatively connected to the tensioner base and the tensioner arm and configured to generate a torque output on the tensioner arm, the tensioner comprising:
a damping mechanism including a shoe plate, a damping shoe and a shoe spring, wherein:
the shoe plate is operatively attached to one of the arm and the base;
the shoe spring is interposed between the shoe plate and the damping shoe such that the damping shoe is radially loaded by the shoe spring and is in sliding engagement with the other of the arm and the base to generate a damping force; and
wherein the damping force and the torque output are independently variable.

2. The rotary belt tensioner of claim 1, further comprising:
a plurality of shoe springs and a plurality of damping shoes, wherein each respective one of the plurality of shoe springs is interposed between the shoe plate and a respective one of the plurality of the damping shoes such that each respective one of the plurality of damping shoes is radially loaded by the respective one of the plurality of shoe springs and is in sliding engagement with the other of the arm and the base to generate a damping force.

3. The rotary belt tensioner of claim 1, further comprising:
three shoe sets, each shoe set including a shoe spring and a damping shoe, wherein:
each respective shoe spring is interposed between the shoe plate and a respective damping shoe such that each damping shoe is radially loaded by the respective shoe spring and is in sliding engagement with the other of the arm and the base to generate a damping force; and
the shoe sets are positioned generally equidistant from each other on the shoe plate.

4. The rotary belt tensioner of claim 1, further including a pulley journaled to the tensioner arm, and an alignment element interposed between the tensioner arm and the tensioner base and configured to align the pulley, wherein the damping mechanism is decoupled from the alignment element.

5. The rotary belt tensioner of claim 1, wherein:
the shoe plate is operatively connected to the arm; and
the torsion element is operatively connected to the shoe plate to operatively connect the base and the arm.

6. The rotary belt tensioner of claim 1, wherein:
the shoe plate is operatively connected to the base; and
the torsion element is connected to the arm.

7. The rotary belt tensioner of claim 1, wherein the damping mechanism is configured to provide a damping force when the tensioner arm is rotated in a clockwise and in a counterclockwise direction.

8. The rotary belt tensioner of claim 1, wherein the damping mechanism is configured to provide Coulomb damping and viscous damping.

9. A damping mechanism configured for installation in a rotary belt tensioner including a torsion element configured to generate a torque output to a tensioner arm rotatably connected to a tensioner base and rotatable in response to the torque output, the damping mechanism comprising:
a shoe spring;
a shoe plate configured to receive a first end of the shoe spring and to be operatively attached to one of the tensioner base and the tensioner arm;
a damping shoe configured to receive a second end of the shoe spring and to slidably interface with the other of the tensioner base and the tensioner arm;
such that when the damping mechanism is installed in the tensioner the shoe spring exerts a radial load on the damping shoe and the damping shoe reacts with the other of the tensioner base and the tensioner arm to generate a damping force; and
wherein the damping mechanism is configured to be decoupled from the tensioner such that the damping force generated by the damping mechanism is independently variable from the output torque.

10. The damping mechanism of claim 9, wherein the damping mechanism is configured to be decoupled from a pulley alignment mechanism of the tensioner.

11. The damping mechanism of claim 9, wherein:
the shoe plate includes a spring guide configured to receive the shoe spring;
the damping shoe includes a spring seat configured to receive the shoe spring; and
the shoe spring is positioned with respect to the spring guide and the spring seat to provide a radial spring force to a damping surface of the damping shoe.

12. The damping mechanism of claim 9, wherein the torsion element is configured as a torsion spring operatively connecting the tensioner arm and tensioner base, wherein:
the shoe plate is operatively connected to the base; and
the torsion spring is connected to the tensioner arm.

13. The damping mechanism of claim 9, wherein:
the shoe plate includes a shoe guide;
the damping shoe includes a plate guide configured to receive the shoe guide to prevent binding of the damping shoe.

14. The damping mechanism of claim 9, wherein the shoe spring is a compression spring sufficiently preloaded to maintain the damping shoe in sliding engagement with the other of the tensioner base and the tensioner arm.

15. The damping mechanism of claim 9, wherein the damping shoe defines a wearing surface, and the damping mechanism is configured to compensate for wear of the wearing surface.

16. The damping mechanism of claim 9, wherein the damping shoe has an arcuate form.

17. The damping mechanism of claim 9, wherein the shoe plate defines at least one opening or recessed portion.

18. The damping mechanism of claim 9, further comprising:
at least one other shoe spring;
wherein the shoe plate is configured to receive a first end of the at least one other shoe spring;
at least one other shoe configured to receive a second end of the at least one other shoe spring and to interface with the other of the tensioner base and the tensioner arm;
such that when the damping mechanism is in an installed position in the tensioner the at least one other shoe spring exerts a radial load on the at least one other shoe and the at least one shoe reacts with the other of the tensioner base and the tensioner arm provides a damping force to the tensioner.

19. A rotary belt tensioner including a tensioner arm rotatably connected to a tensioner base, an alignment element configured to align the tensioner arm and the tensioner base, and a torsion element configured to generate a torque output on the tensioner arm, the tensioner comprising:
a damping mechanism including a shoe plate and a plurality of shoe sets, wherein:
the shoe plate is operatively attached to the arm;
each of the plurality of shoe sets includes a shoe spring interposed between the shoe plate and a damping shoe such that the damping shoe is radially loaded by the shoe spring to react with the base to generate a damping force;
the torsion element has a first end operatively connected to the shoe plate and a second end operatively connected to the base; and
the damping mechanism is sufficiently decoupled from the alignment element such that the damping force and the tensioner arm alignment are independently variable.

20. The tensioner of claim 19, wherein the damping mechanism is sufficiently decoupled from the torsion element such that the damping force and the torque output are independently variable.
